(19) United States
(12) Patent Application Publication
(10) Pub. No.: US 2009/0052660 A1
(43) Pub. Date: Feb. 26, 2009

(54) Method For Encrypting And Decrypting Instant Messaging Data

(75) Inventors: Weihua Chen, Shenzhen (CN); Ziguang Gao, Shenzhen (CN); Mao Ye, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (CN)

(21) Appl. No.: 12/259,334

(22) Filed: Oct. 28, 2008

Related U.S. Application Data
(63) Continuation of application No. PCT/CN2007/001437, filed on Apr. 28, 2007.

(30) Foreign Application Priority Data
Apr. 28, 2006 (CN) 200610060566.9

(51) Int. Cl. H04L 9/08

(52) U.S. Cl. 380/30

(57) ABSTRACT

This invention provides a method for encrypting and decrypting Instant Messaging data. A client encrypts Instant Messaging data using a data encryption key and transmits the data encryption key to a server; the server encrypts the data encryption key using a uniform server key and transmits the encrypted data encryption key to the client. When the server needs to assist with decryption, the client transmits to the server a data encryption key encrypted using a uniform server key; the server acquires the data encryption key and transmits it to the client; the client decrypts Instant Messaging data locally stored using the data encryption key. By embodiments of this invention, server doesn't need to store one key for encrypting and decrypting data encryption key for each client, only needs to store a uniform server key, thereby saving storage spaces of server, and reducing the burden of server performing encrypting and decrypting.

### CROSS-REFERENCE TO RELATED APPLICATIONS

This application is a continuation of International Application No. PCT/CN2007/001437, filed Apr. 28, 2007. This application claims the benefit and priority of Chinese Application No. 200610060566.9, filed Apr. 28, 2006. The entire disclosure of each of the above applications is incorporated herein by reference.

### FIELD

The present disclosure relates to Instant Messaging technologies, more particularly to a method for encrypting and decrypting Instant Messaging data.

### BACKGROUND

This section provides background information related to the present disclosure which is not necessarily prior art.

An Instant Messaging system is a system that is able to instantly transmit and receive an Internet message. Through the Instant Messaging system, text messages or files can be transmitted between users and communication actions, such as audio dialog and video dialog can be performed between the users. Along with the rapid development of computer networks, the Instant Messaging system has become a communication tool that is popularly used by the users.

FIG. 1 shows a network structure for performing Instant Messaging between clients. The Instant Messaging system is run on multiple clients. Communications are performed between clients and between a client and a server through User Datagram Protocol (UDP). When a user logs in the Instant Messaging system, a client corresponding to the user is connected to the server, and acquires a list of online contacts from the server. When the user performs Instant Messaging with one online contact, if the communication connection of two parties is relatively steady, messages of the two parties are transmitted between the client corresponding to the user and the client corresponding to the online contact through UDP. If the communication connection of the two parties is not steady, or one of the two parties is off line, the messages are transferred through the server. The client may be a Personal Computer (PC), a Personal Digital Assistant (PDA), a mobile phone, etc., and the server may be one of large-sized, medium-sized, and small-sized servers.

In order to guarantee the security of the communication, Instant Messaging data of an Instant Messaging user in the process of the communication, such as communication records, contact information and user information, can be encrypted and stored in the client of the Instant Messaging user, and the encrypted Instant Messaging data is decrypted when the Instant Messaging data is needed. In the prior art, a symmetry encryption technology is commonly used between the client and the server. The symmetry encryption technology include: the client and the server respectively encrypt a key for encrypting and decrypting Instant Messaging data. When needing to acquire the Instant Messaging data stored locally, the user decrypts the Instant Messaging data using the key of the user side. If the user fails to decrypt the Instant Messaging data, the user requests the server to assist with decryption, thereby ensuring the security of the user acquiring the Instant Messaging data.

However, the server usually adopts different keys for different clients. When there are a large number of clients, not only plentiful storage spaces of the server are occupied, but also the burden of the server performing encrypting and decrypting is increased.

### SUMMARY

This section provides a general summary of the disclosure, and is not a comprehensive disclosure of its full scope or all of its features.

The first object of the embodiments of the present invention is to provide a method for encrypting Instant Messaging data, so as to greatly save storage spaces of the server and reduce the burden of the server performing encrypting when there are a large number of clients.

The second object of the embodiments of the present invention is to provide a method for decrypting Instant Messaging data, so as to greatly save storage spaces of the server and reduce the burden of the server performing decrypting when there are a large number of clients.

A method for encrypting Instant Messaging data includes:
encrypting, by a client, Instant Messaging data using a data encryption key generated by the client, and transmitting the encrypted data encryption key to a server;
encrypting, by the server, the data encryption key using a uniform server key generated by the server, and transmitting the encrypted data encryption key to the client.

A method for decrypting Instant Messaging data includes:
transmitting, by a client, to a server a data encryption key encrypted using a uniform server key;
decrypting, by the server, the data encryption key encrypted by the client using the uniform server key, and transmitting the decrypted data encryption key to the client;
decrypting, by the client, Instant Messaging data locally stored using the data encryption key.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating a network structure for performing Instant Messaging between clients.

FIG. 2 is a flowchart illustrating a method for encrypting Instant Messaging data in accordance with a first embodiment of the present invention.

FIG. 3 is a flowchart illustrating a method for encrypting Instant Messaging data in accordance with a second embodiment of the present invention.

FIG. 4 is a flowchart illustrating a method for decrypting Instant Messaging data in accordance with a third embodiment of the present invention.

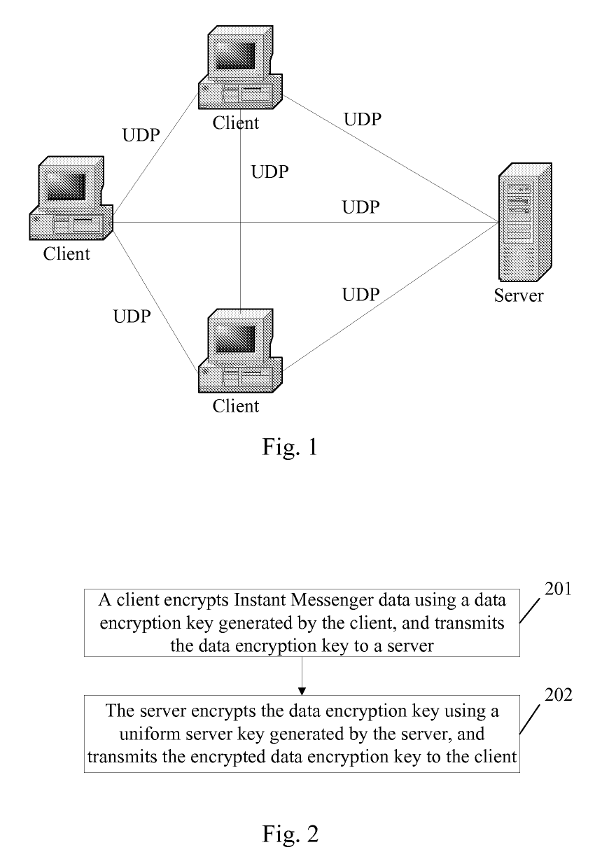

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,”“specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The present invention is hereinafter described in detail with reference to the accompanying drawings and embodiments to make the object, solution and merits thereof more apparent. It should be noted that the embodiments here are only used to explain the present invention and are not for use in limiting the protection scope thereof.

FIG. 2 is a flowchart in accordance with a first embodiment of the present invention. As shown in FIG. 2, the method for encrypting Instant Messaging data includes the following processes.

Block 201: A client encrypts Instant Messaging data using a data encryption key generated by the client, and transmits the data encryption key to a server.

In this process, the client may generate the data encryption key randomly. Specifically, this process includes: the client randomly generates a key as the data encryption key; the client encrypts the Instant Messaging data locally stored using the data encryption key; the client transmits the data encryption key to the server.

In practical application, in order to better improve the security of the data encryption key, after the process of randomly generating the data encryption key, the following process is further included: the client further encrypts the data encryption key using a client key which the client has.

In other words, the client does not store the data encryption key directly, but stores the data encryption key after further encrypting the data encryption key. The client key here may be an Instant Messaging log-in password which the client has. Of course, in practical application, the client key may not be the Instant Messaging log-in password if only the data encryption key is further encrypted.

Block 202: The server encrypts the data encryption key using a uniform server key generated by the server, and transmits the encrypted data encryption key to the client.

In this process, the uniform server key is a global variable randomly generated by the server, and is used to uniformly encrypt data encryption keys transmitted by different clients.

In order to better explain the method for encrypting Instant Messaging data, a second embodiment is used to perform message description.

In the second embodiment, suppose that the data encryption key generated by the client is indicated as key; the result of encrypting the key by the client using the Instant Messaging log-in password is indicated as Ukey1; the result of encrypting the key by the server using the uniform server key is indicated as KSs(key).

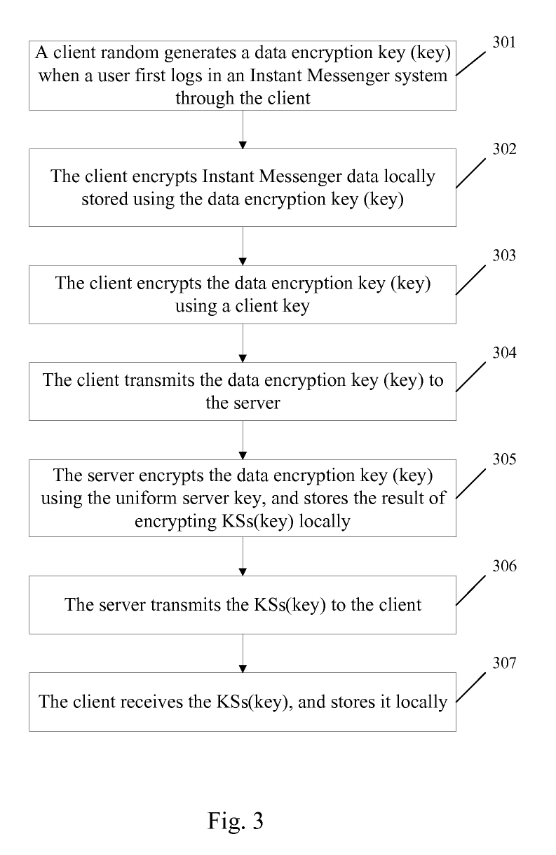

FIG. 3 is a flowchart in accordance with a second embodiment of the present invention. As shown in FIG. 3, the method for encrypting Instant Messaging data implemented by the second embodiment includes the following processes.

Block 301: A client randomly generates a data encryption key (key) when a user first logs in an Instant Messaging system through the client.

Block 302: The client encrypts Instant Messaging data locally stored using the data encryption key (key).

Block 303: The client encrypts the data encryption key (key) using a client key.

In other words, the client may encrypt the key using, e.g., the Instant Messaging log-in password, and the result of encrypting is Ukey1. The client stores the Ukey1 locally.

Block 304: The client transmits the data encryption key (key) to the server.

Block 305: The server encrypts the data encryption key (key) using the uniform server key, and may store the result of encrypting, i.e. the KSs(key) locally.

In this Process, the uniform server key is a global variable randomly generated by the server, and is used to uniformly encrypt data encryption keys transmitted by different clients.

Block 306: The server transmits the KSs(key) to the client.

Block 307: The client receives the KSs(key), and stores the KSs(key) locally.

In an embodiment of the present invention, both the client and the server stores information which can be used to acquire the data encryption key, the information stored in the client is Ukey1, and the information stored in the server is KSs(key). Afterwards, when the user needs to acquire the Instant Messaging data locally stored, the Instant Messaging data may be decrypted in an off-line mode. Specifically, the client first decrypts the Ukey1 using the client key to acquire the data encryption key (key), and then decrypts the Instant Messaging data using the data encryption key (key) to acquire the Instant Messaging data.

In practical application, if the decryption for Ukey1 performed by the client fails, the client needs to request the server to assist with decryption.

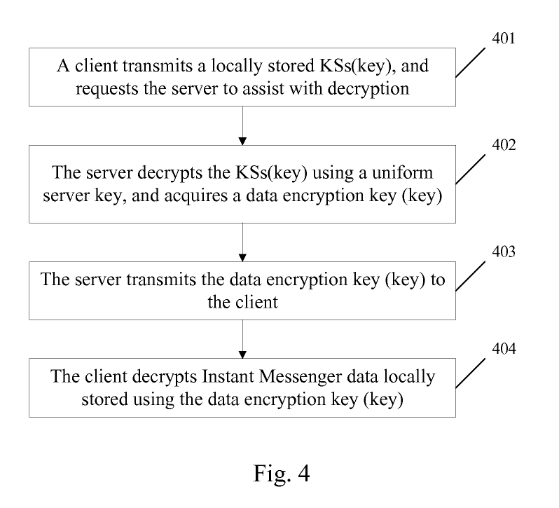

FIG. 4 is a flowchart illustrating the implementation of a server assisting a client with decryption, i.e. a flowchart in accordance with a third embodiment of the present invention. As shown in FIG. 4, the third embodiment includes the following processes.

Block 401: A client transmits locally stored KSs(key), and requests the server to assist with decryption.

Block 402: The server decrypts the KSs(key) using a uniform server key, and acquires a data encryption key (key).

Block 403: The server transmits the data encryption key (key) to the client.

Block 404: The client decrypts Instant Messaging data locally stored using the data encryption key (key).

In another embodiment of the present invention, the server is able to generate a uniform server key, and encrypts data encryption keys transmitted by different clients using the uniform server key; correspondingly, when receiving a request for assisting a client with decryption, the server is able to directly perform decryption using the uniform server key. In this way, the server does not need to store, for each client, one key specially used for encrypting and decrypting a data encryption key. The server can only need to store a uniform server key, so the storage spaces of the server is greatly saved, and the burden of the server performing encrypting and decrypting is reduced.

The above are only preferred embodiments of the present invention and are not for use in limiting the protection scope of the present invention. All modifications, equivalent replacements or improvements made within the principles of the present invention should be covered under the protection scope of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for encrypting Instant Messaging data, comprising:
encrypting, by a client, Instant Messaging data using a data encryption key generated by the client, and transmitting the encrypted data encryption key to a server;
encrypting, by the server, the data encryption key using a uniform server key generated by the server, and transmitting the encrypted data encryption key to the client.

2. The method of claim 1, wherein the encrypting, by a client, Instant Messaging data using a data encryption key generated by the client comprises:
randomly generating, by the client, a key as the data encryption key;
encrypting, by the client, the Instant Messaging data locally stored using the data encryption key.

3. The method of claim 2, further comprising:
encrypting, by the client, the data encryption key using a client key which the client has after encrypting the Instant Messaging data using the data encryption key generated by the client.

4. The method of claim 3, wherein the client key is an Instant Messaging log-in password which the client has.

5. The method of claim 1, wherein the uniform server key is a global variable randomly generated by the server and is used to uniformly encrypt data encryption keys transmitted by different clients.

6. A method for decrypting Instant Messaging data, comprising:
transmitting, by a client, to a server a data encryption key encrypted using a uniform server key;
decrypting, by the server, the data encryption key encrypted by the client using the uniform server key, and transmitting the decrypted data encryption key to the client;
decrypting, by the client, Instant Messaging data locally stored using the data encryption key.

7. The method of claim 6, wherein the uniform server key is a global variable randomly generated by the server and is used to uniformly encrypt data encryption keys transmitted by different clients.
